(19) United States
(12) Patent Application Publication
(10) Pub. No.: US 2018/0311965 A1
(43) Pub. Date: Nov. 1, 2018

(54) FLUID SUPPLY ASSEMBLY

(71) Applicant: Hewlett-Packard Development Company, L.P., Houston, TX (US)

(72) Inventors: Justin M. Roman, Portland, OR (US); Jeffrey G. Bingham, Vancouver, WA (US); Sam Sing, Vancouver, WA (US)

(73) Assignee: Hewlett-Packard Development Company, L.P., Houston, TX (US)

(21) Appl. No.: 15/763,205

(22) PCT Filed: Jan. 22, 2016
(86) PCT No.: PCT/US2016/014404

§ 371 Date: Mar. 26, 2018

(51) Int. Cl. B41J 2/175

(52) U.S. Cl. CPC B41J 2/17523

(57) ABSTRACT

In an example implementation, a fluid supply assembly includes a printhead assembly (PHA) attachable to a printing system carriage. A first fluid conduit permanently affixed to the PHA, and a second fluid conduit is attachable to the first fluid conduit by a fluid conduit coupling to enable fluid to flow from an off-axis fluid supply to the PHA.

### BACKGROUND

Printing systems are a type of fluid dispensing system that can be used to print images and/or text onto a print medium or print target. Some printing systems can include a moveable carriage to which a printhead assembly is attached. The printhead assembly can deliver printing fluid to a print medium or print target during operation of the printing system. Printing fluid can be supplied to a printhead assembly by an on-axis fluid supply that travels along with the printhead assembly on the moveable carriage, or by an off-axis, stationary fluid supply that supplies fluid to the printhead assembly through a tube or other fluid conduit.

### BRIEF DESCRIPTION OF THE DRAWINGS

Examples will now be described with reference to the accompanying drawings, in which:

FIG. 1 shows a block diagram of an example printing system in which examples of a fluid supply assembly may be implemented;

FIG. 2 shows an example fluid supply assembly in which a fluid pump is incorporated to facilitate the flow of printing fluid from an off-axis printing fluid supply to the printhead assembly;

FIG. 3 shows an example of a fluid supply assembly in which multiple off-axis printing fluid supplies are interconnected by a fluid conduit to a printhead assembly;

FIG. 4a, FIG. 4b, and FIG. 4c show portions of an example fluid supply assembly illustrating a printhead assembly in different stages of attachment to a printing system carriage;

FIG. 5 shows a perspective view of an example printhead assembly attached to a printing system carriage via a latching mechanism and corresponding latching components.

Throughout the drawings, identical reference numbers designate similar, but not necessarily identical, elements.

### DETAILED DESCRIPTION

Printing systems, such as various inkjet printing systems, can include on-axis and off-axis printing fluid supply systems to facilitate the printing of text and/or images onto print media. Some example printing systems can include both on-axis and off-axis fluid supplies, while other example systems can include either on-axis or off-axis fluid supplies. An on-axis printing fluid supply system includes one or multiple printing fluid supplies that are installed on or integrated within a printhead assembly. A printing fluid supply includes a container that holds printing fluid that is to be delivered to the printhead assembly. A printing fluid can include various types of printing fluids, such as different colored inks (e.g., cyan, magenta, yellow, black ink), or other types of printing fluid such as finishing fluids, fusing agents, and so on. Use of the term “ink” herein is intended to generally include various types of printing fluids.

A print medium can include paper, a transparency foil, or any other medium onto which printing fluid can be deposited to form an image and/or text. More generally, a print target can refer to either a two-dimensional (2D) print medium or a three-dimensional (3D) structure on which 3D printing can be performed. Accordingly, although reference is made herein to a “print medium,” it is noted that techniques and/or mechanisms presented throughout this disclosure can also be used with a 3D print target such as a bed of print material, for example. Thus, in different examples, a “printing system” may refer to a 2D printing system or a 3D printing system.

A printhead assembly can include one or multiple printing fluid ejectors to eject printing fluid (received from the one or multiple printing fluid supplies) onto a print medium during operation of the printing system. The printhead assembly can be attached to a moveable carriage of the printing system. During operation of the printing system, the moveable carriage of the printing system can move back and forth with respect to the print medium as printing fluid is deposited onto the print medium. With an on-axis fluid printing supply system, the printing fluid supply or supplies installed in the printhead assembly move with the carriage.

An off-axis printing supply system includes one or multiple printing fluid supplies that are separated from the printhead assembly. An off-axis printing fluid supply can be attached to another part of the printing system that is remote from the printhead assembly. Thus, an off-axis fluid supply remains stationary with respect to the printhead assembly and carriage during operation of the printing system when the printhead assembly and carriage are moved back and forth to print onto a print medium. In some examples, an off-axis fluid supply can be attached outside of and away from the printing system. A print fluid conduit can be used to communicate printing fluid between each respective printing fluid supply and printing fluid ejector (e.g., printhead) within the printhead assembly. A print fluid conduit can include, for example, one or multiple flexible tubes or other types of fluid communication structures.

In some example printing systems, different carriage designs are provided for respective on-axis and off-axis printing fluid supply systems. While an example printing system may have a carriage designed to accommodate an on-axis printing fluid supply system, customers often desire to have an off-axis fluid supply because it provides a larger volume of ink than is available from an on-axis fluid supply. However, a carriage designed for an off-axis printing fluid supply system may be different from a carriage designed for an on-axis printing fluid supply system, since the carriage for the off-axis printing fluid supply system will accommodate fluid conduits (e.g. tubes) from the off-axis printing fluid supplies. Having to reconfigure a carriage designed for an on-axis printing fluid supply system to operate with an off-axis printing fluid supply system can add cost and time delay to the development of printing systems.

Accordingly, examples presented herein of a fluid supply assembly in a printing system provide access to an off-axis printing fluid supply using a carriage designed for use with an on-axis fluid supply. The fluid supply assembly includes a printhead assembly (PHA) with an integrated fluid conduit to supply printing fluid from an off-axis supply. The fluid conduit includes an in-line fluid conduit coupling that provides a make-break connection. The in-line fluid conduit coupling bifurcates the fluid conduit such that upon uncoupling or breaking the connection, a first portion of the fluid conduit remains permanently affixed to the printhead assembly while a second portion of the fluid conduit remains connected to the printing system. The second portion of the fluid conduit leads to and provides a fluid pathway from an off-axis fluid supply. The printhead assembly is removably attachable to the printing system carriage by a latching mechanism. Thus, upon uncoupling of the in-line fluid conduit coupling and detaching the printhead assembly from the carriage, the printhead assembly can be readily removed and serviced or replaced by a customer.

In an example implementation, a fluid supply assembly includes a printhead assembly (PHA) attachable to a printing system carriage. A first fluid conduit is permanently affixed to the PHA, and a second fluid conduit is attachable to the first fluid conduit by a fluid conduit coupling to enable fluid to flow from an off-axis fluid supply to the PHA.

In another example implementation, a printing system includes a fluid supply assembly that comprises an on-axis printhead assembly (PHA). The PHA is removably attachable to a carriage with a latching mechanism. A first fluid conduit is integrated with the PHA to deliver fluid to the PHA, and a second fluid conduit is to deliver fluid from an off-axis fluid supply to the first fluid conduit. A make-break coupling is to detachably couple the first fluid conduit with the second fluid conduit.

In another example implementation, a fluid supply assembly to provide printing fluid to a printing system includes an off-axis printing fluid supply and an on-axis printhead assembly. A first fluid conduit is permanently incorporated into the printhead assembly, and a second fluid conduit is attachable to the printing fluid supply. An in-line, make-break fluid conduit coupling is to couple the first fluid conduit with the second fluid conduit to enable fluid to flow to the printhead assembly from the printing fluid supply.

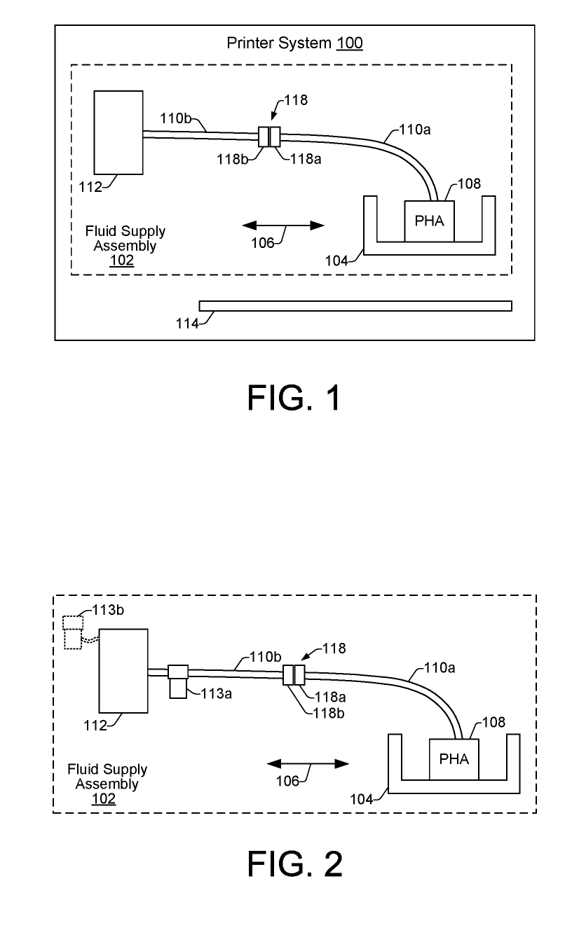

FIG. 1 shows a block diagram of an example printing system 100 in which examples of a fluid supply assembly 102 may be implemented. As shown in FIG. 1, an example fluid supply assembly 102 includes a moveable carriage 104. The carriage 104 can be slidably mounted onto a printing system shaft (not shown) and translated back and forth along the shaft as indicated by the directional arrow 106 in response to communications and/or control signals from a printing system controller (not shown). The carriage 104 is able to receive a printhead assembly (PHA) 108 that can be removably attached to the carriage 104.

The printhead assembly (PHA) 108 includes a permanently attached printing fluid conduit 110 (illustrated as a first fluid conduit 110a and a second fluid conduit 110b, discussed below). The printing fluid conduit 110 can be interconnected with an off-axis printing fluid supply 112 to enable printing fluid to flow from the off-axis printing fluid supply 112 to the PHA 108. In some examples, the printing fluid can flow from the fluid supply 112 to the PHA 108 under the force of gravity. In some examples, the printing system 100 can include a pump to facilitate and/or cause the flow of printing fluid from the off-axis printing fluid supply 112 to the PHA 108. In some examples, the printing system 100 can include multiple off-axis printing fluid supplies 112 that are interconnected by the fluid conduit 110 to the PHA 108.

FIG. 2 shows an example fluid supply assembly 102 in which a fluid pump 113 (illustrated as fluid pump 113a and fluid pump 113b) is incorporated to control the flow of printing fluid from the off-axis printing fluid supply 112 to the PHA 108. A fluid pump 113 can be activated and controlled, for example, by a controller (not shown) of the printing system 100. In different implementations, a fluid pump 113 may be positioned in different locations within the fluid supply assembly 102. For example, as shown in FIG. 2, in one implementation a fluid pump 113a can be positioned in-line with the fluid conduit 110. In an alternate implementation, a fluid pump 113b (illustrated in dashed lines) can be positioned at the off-axis fluid supply 112. A fluid pump 113 can be any suitable type of pump to push fluid through the fluid conduit 110 including, for example, a fluid pump, a pneumatic pump, a pneumatic driven fluid pump, and so on.

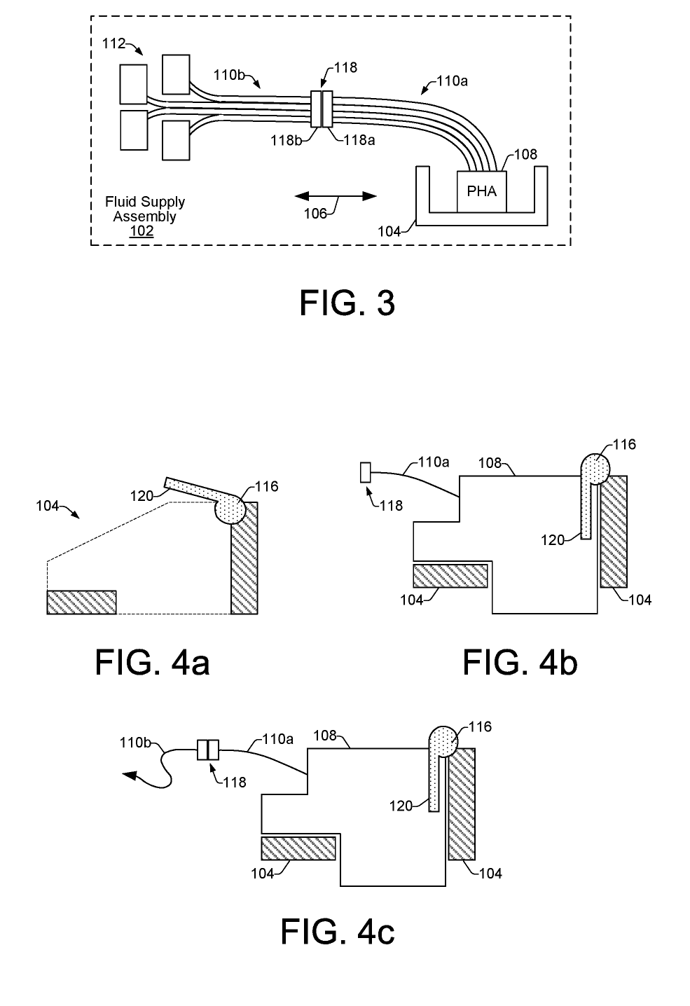

FIG. 3 shows an example fluid supply assembly 102 in which multiple off-axis printing fluid supplies 112 are interconnected by a fluid conduit 110 to the PHA 108. In examples such as shown in FIG. 3, the fluid conduit 110 can comprise flexible ribbon tubing that includes multiple tubes or fluid paths for interconnecting the printing fluid supplies 112 to the PHA 108. The fluid conduit/tubing 110 can be made of various materials such as nylon, polyurethane, polyethylene, polypropylene, poly-vinyl chloride, synthetic rubber, natural rubber, polymer, plastic, Teflon, metal, and combinations thereof. The printing fluid supplies 112 can contain various printing fluids, such as different colored inks, finishing fluids, fusing agents, and so on. Although not specifically illustrated, in some examples the multiple off-axis fluid supplies 112 can be connected to a fluid pump such as the fluid pump 113 shown and discussed with regard to FIG. 2. Such a pump can be connected to the fluid supplies 112 through pressure pipes, and can be activated in a selective manner by a controller (not shown) to pressurize the fluid supplies 112 to cause fluid from a particular supply 112 to flow through a particular tube or fluid pathway to the PHA 108.

Referring to FIGS. 1-3, a printing fluid supply 112 can be said to be an “off-axis” printing fluid supply 112 because it is located away from the carriage 104 and remains in a stationary position within the printing system 100 during operation of the printing system 100. In some examples, an off-axis printing fluid supply 112 may be located outside of and away from the printing system 100. Conversely, the PHA 108 can be said to be an “on-axis” PHA 108 because of its attachability to the carriage 104, which enables the PHA 108 to move with the carriage 104 as it translates in a back and forth direction as indicated by the directional arrow 106.

During operation of the printing system 100, as the printhead assembly 108 translates in a back and forth direction 106 with the carriage 104, it can eject printing fluid from one or multiple printing fluid ejectors onto a print target or print medium 114 to generate text and/or images in response to communications and/or control signals from the printing system controller (not shown). In some example implementations, the carriage 104 can be a stationary carriage that extends across a width of a print medium 114. In such examples, a printhead assembly 108 attached to a stationary carriage 104 may include enough printing fluid ejectors to extend across the width of the print medium 114 along the stationary carriage. In addition, the print medium 114 may be moveable relative to the stationary carriage 104. A print medium 114 or print target can include, for example, suitable cut-sheet or roll-fed media such as paper, card stock, transparencies, fabric, canvas, polyester, and so on. In some examples, as noted above, a print target can also refer to a 3D structure or 3D bed of print material for use in a 3D printing system.

The ability to provide increased volumes of printing fluid to the PHA 108 from an off-axis printing fluid supply 112 through a printing fluid conduit 110 enables the use of a single carriage design across various printing systems. The versatility of using off-axis printing fluid supplies helps extend the applicability of such printing systems to a wider range of printing applications, for example, from small, home or personal printing applications, to larger industrial or commercial printing applications that consume more printing fluid. In various printing applications, the ability to remove the PHA 108, and then to service or replace the PHA 108, can be a desirable feature that enables consumers to quickly and efficiently service printing systems while reducing printing downtime.

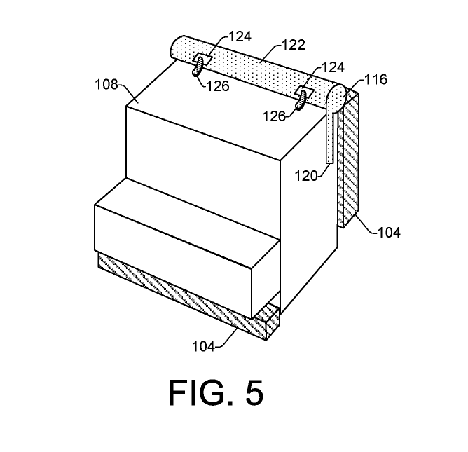

Accordingly, as shown in FIGS. 1-5, additional features of an example fluid supply assembly 102 in an example printing system 100 include a latching mechanism 116 and a make-break fluid conduit coupling 118 to facilitate a quick attachment and removal of the printhead assembly 108 from the printing system 100. FIG. 4 (illustrated as FIG. 4a, FIG. 4b, and FIG. 4c) shows portions of an example fluid supply assembly 102 where the PHA 108 is in different stages of attachment to the carriage 104 of a printing system 100 via a latching mechanism 116 and a make-break fluid conduit coupling 118. FIG. 5 shows a perspective view of an example PHA 108 attached to the carriage 104 via a latching mechanism 116 and corresponding latching components.

A latching mechanism 116 can include a moveable lever 120 (or other type of moveable member) that can be actuated by a user between an unlocked position (the position shown in FIG. 4a) and a locked position (the position shown in FIGS. 4b and 4c). In some examples, as shown in FIG. 5, the latching mechanism 116 can include a rotatable latch spindle 122 with latch openings 124 for receiving respective engagement members 126 of the printhead assembly 108. In some implementations, the engagement members 126 can be in the form of protrusions 126 (e.g. horns) that can be received into the latch openings 124 of the latch spindle 122.

Although a particular example of a latching mechanism 116 for engaging the engagement members 126 of the printhead assembly 108 from the carriage 104 has been shown and described with respect to FIGS. 4-5, it is noted that in other examples, other types of latching mechanisms for engaging the PHA 108 can be used. Furthermore, although the example latching mechanism 116 is shown as being part of the carriage 104, it is noted that in other examples the latching mechanism 116 can be provided on the PHA 108, for latching engagement members on the carriage 104.

More generally, it is noted that the carriage 104 comprises an attachment mechanism that is removably attachable to an engagement element of the PHA 108. The attachment mechanism can be the latching mechanism 116, or alternatively, it can be any type of attachment element that is engageable with a latching mechanism provided on the PHA 108.

In addition to detaching the PHA 108 from the carriage 104 with the latching mechanism 116, removing the PHA 108 from the printing system 100 involves separating or uncoupling the PHA 108 from the off-axis printing fluid supply 112. As shown in FIGS. 1-3 and as noted above, the PHA 108 incorporates an integrated fluid conduit 110 that is permanently affixed to the PHA 108. More specifically, the PHA 108 incorporates and is permanently affixed to a first fluid conduit 110a (i.e., a first part of fluid conduit 110), while a second fluid conduit 110b is attachable to the off-axis printing fluid supply 112.

The fluid conduit 110 is bifurcated into the first fluid conduit 110a and the second fluid conduit 110b by the make-break fluid conduit coupling 118. The make-break fluid conduit coupling 118 is in-line with the fluid conduit 110 to enable a quick coupling of the PHA 108 to the off-axis printing fluid supply 112 and a quick detachment of the PHA 108 from the off-axis printing fluid supply 112. More particularly, the make-break fluid conduit coupling 118 provides for the coupling of the first fluid conduit 110a to the second fluid conduit 110b to enable printing fluid to flow from the off-axis printing fluid supply 112 to the PHA 108.

An in-line make-break fluid conduit coupling 118 can be implemented, for example, as any appropriate fluidic conduit coupling mechanism that functions as a self-sealing disconnect device. Such fluidic conduit coupling mechanisms can include, for example, ball valves, needle valves, push-button thumb latches, needle/septum devices, and so on. In some examples, the make-break fluid conduit coupling 118 can be implemented as a needle-septum device. A needle-septum device comprises a self-sealing disconnect device that operates with two separate components (118a, 118b), a septum and a hollow needle. One of the components 118a can be coupled to the first fluid conduit 110a, while the other component 118b can be coupled to the second fluid conduit 110b. When the two components are engaged by bringing the first and second fluid conduits 110a and 110b together, the hollow needle pierces the septum and the make-break fluid conduit coupling 118 allows the flow of printing fluid from the off-axis fluid supply 112 to the PHA 108 through the first and second fluid conduits 110a and 110b.

When the PHA 108 is to be removed from the printing system 100, the first fluid conduit 110a can be detached from the second fluid conduit 110b by withdrawing the hollow needle from the septum. Upon withdrawal of the needle from the septum, the septum closes and the make-break fluid conduit coupling 118 prevents the flow of printing fluid. In general, regardless of the type of fluidic conduit coupling mechanism used, when a user disconnects the first and second fluid conduits 110a and 110b, the make-break fluid conduit coupling 118 automatically seals the conduits.

What is claimed is:

1. A fluid supply assembly comprising:
a printhead assembly (PHA) attachable to a printing system carriage;
a first fluid conduit permanently affixed to the PHA;
a second fluid conduit attachable to the first fluid conduit by a fluid conduit coupling to enable fluid to flow from an off-axis fluid supply to the PHA.

2. A fluid supply assembly as in claim 1, wherein the PHA and first fluid conduit are removable from the printing system upon detachment of the PHA from the carriage and detachment of the first fluid conduit from the second fluid conduit at the fluid conduit coupling.

3. A fluid supply assembly as in claim 1, wherein the first and second fluid conduits comprise flexible ribbon tubing having multiple fluid paths for interconnecting multiple off-axis fluid supplies to the PHA.

4. A fluid supply assembly as in claim 1, further comprising a fluid pump to cause fluid to flow from an off-axis fluid supply to the PHA.

5. A fluid supply assembly as in claim 1, wherein the fluid conduit coupling comprises:
a first component affixed to an end of the first fluid conduit;
a second component affixed to an end of the second fluid conduit;
wherein the first and second components comprise a make-break connector to enable a quick connect and disconnect between the first and second fluid conduits.

6. A fluid supply assembly as in claim 5, wherein;
the first component comprises a septum; and
the second component comprises a hollow needle to pierce the septum and enable fluid to flow from the off-axis fluid supply, and through the first and second fluid conduits to the PHA.

7. A fluid supply assembly as in claim 1, further comprising:
an attachment mechanism integrated with the carriage; and,
an engagement mechanism integrated with the PHA and removably attachable to the attachment mechanism to attach the PHA to, and detach the PHA from, the carriage.

8. A fluid supply assembly as in claim 7, wherein the attachment mechanism comprises a latch with a moveable lever, the engagement element comprises a protrusion engageable with the latch, and the moveable lever is user-actuatable between an unlocked position and a locked position, the unlocked position allowing for detachment of the PHA from the carriage, and the locked position to secure the PHA to the carriage.

9. A printing device with a fluid supply assembly, the fluid supply assembly comprising:
an on-axis printhead assembly (PHA) removably attachable to a carriage with a latching mechanism;
a first fluid conduit integrated with the PHA to deliver fluid to the PHA;
a second fluid conduit to deliver fluid from an off-axis fluid supply to the first fluid conduit;
a make-break coupling to detachably couple the first fluid conduit with the second fluid conduit.

10. A printing device as in claim 9, wherein the latching mechanism is integrated with one of the PHA or the carriage.

11. A printing device as in claim 9, wherein;
the first fluid conduit comprises a first set of fluid conduits, each fluid conduit in the first set to deliver a different fluid to the PHA; and
the second fluid conduit comprises a second set of fluid conduits corresponding with the first set of fluid conduits to deliver the different fluids to the first set of fluid conduits through the make-break coupling.

12. A printing device as in claim 9, wherein the make-break coupling comprises a needle-septum fluid conduit coupling.

13. A fluid supply assembly to provide printing fluid to a printing system, the fluid supply assembly comprising:
an off-axis printing fluid supply;
an on-axis printhead assembly;
a first fluid conduit permanently incorporated into the printhead assembly;
a second fluid conduit attachable to the printing fluid supply; and
an in-line make-break fluid conduit coupling to couple the first fluid conduit with the second fluid conduit to enable fluid to flow to the printhead assembly from the printing fluid supply.

14. A fluid supply assembly as in claim 13, further comprising:
a carriage to traverse a print medium;
a latching mechanism; and
a user-actuatable lever to move the latching mechanism between a locked position in which the printhead assembly is attached to the carriage and an unlocked position in which the printhead assembly is detached from the carriage.

15. A fluid supply assembly as in claim 14, wherein the latching mechanism is disposed on the carriage, the fluid supply assembly further comprising:
a rotatable latch spindle of the latching mechanism;
engagement members of the printhead assembly; and
latch openings in the rotatable latch spindle to receive the engagement members to secure the printhead assembly to the carriage.
